(19) United States
(12) Patent Application Publication
(10) Pub. No.: US 2007/0262655 A1
(43) Pub. Date: Nov. 15, 2007

(54) POWER SUPPLY AND SWITCH APPARATUS THEREOF

(75) Inventors: Chiu-Yuan Lin, Tainan City (TW); Shih-Chung Huang, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: BEYOND INNOVATION TECHNOLOGY CO., LTD., Taipei City (TW)

(21) Appl. No.: 11/554,583

(22) Filed: Oct. 30, 2006

(30) Foreign Application Priority Data
May 15, 2006 (TW) 95117080

(51) Int. Cl. H01H 47/00

(52) U.S. Cl. 307/140

(57) ABSTRACT

A power supply and a switch apparatus are disclosed. The power supply is designed for providing a liquid crystal display with a power source. In the present invention, a bouncing switch is used for power-on and power-off functions. When the bouncing switch is activated, the power to the main system is also activated and the supply of power to the main system is maintained. A controller of the main system is then activated to acquire an authorization for controlling the power to the main system so that power is continuously supplied to the main system. Then, the main system sequentially activates the power supply of each sub-system. If the bouncing switch is activated by a second triggering, the main system may sequentially turns off the power module inside each sub-system. Finally, the power to the main system is shut down to lower the static power consumption of the whole system.

### CROSS-REFERENCE TO RELATED APPLICATION

This application claims the priority benefit of Taiwan application serial no. 95117080, filed May 15, 2006. All disclosure of the Taiwan application is incorporated herein by reference.

### BACKGROUND OF THE INVENTION

1. Field of the Invention

The present invention relates to a power supply designed for providing a liquid crystal display with a power source and including a sequential activating circuit designed with various power supply methods.

2. Description of Related Art

Liquid crystal display (LCD) has the advantage of a slimmer body and occupies less space than the conventional cathode ray tube (CRT). Therefore, an increasing number of liquid crystal displays are used as a large television at home or a viewing panel in public places. The power supply system of a liquid crystal display typically includes power source modules such as a 5V conversion circuit, a VGH conversion circuit, a VGL conversion circuit and a CCFL driving circuit for converting the power source into voltages required by various devices and supplying the devices.

FIG. 1 is a schematic circuit diagram of a conventional power supply circuit. As shown in FIG. 1, when a power source PS input is provided, each of the power modules (the 5V conversion circuit 12, the VGH conversion circuit 22, the VGL conversion circuit 24 and the CCFL driving circuit 26) begins to operate by supplying power to an LCD module signal control circuit 10 and an LCD module display 20. The LCD module signal control circuit 10 outputs signal to the LCD module display 20. According to the received VGL, VGH, 5V voltage signals and the control signal provided by the LCD module signal control circuit 10, the LCD module display 20 displays an image signal on a screen. However, when the LCD module signal control circuit 10 and the LCD module display 20 are in a standby mode and stop operating, each of the power modules still supply power leading to considerable waste of energy. In particular, for a system powered by a battery, if the power system is not cut off when the LCD module signal control circuit 10 and the LCD module display 20 are not in use, a small current has to be continuously provided to the system. As a result, the continuity of the battery power is weakened.

Since the current liquid crystal display power supply system has no provision for stopping the supply of power in the idle state, considerable power is wasted. For a portable system operated by battery power, the battery life is lowered significantly.

### SUMMARY OF THE INVENTION

Accordingly, at least one objective of the present invention is to provide a power supply mainly designed for providing a liquid crystal display with a power source. The power supply mainly includes a sequential activating circuit and a number of different power supply methods. In the present invention, a bouncing switch is used for power-on and power-off functions. When the bouncing switch is activated, power to the main system is also activated and the supply of power to the main system is maintained. A controller of the main system is then activated to acquire an authorization for controlling the power to the main system so that power is continuously supplied to the main system. Then, the main system sequentially activates the power supply of each sub-system. In addition, if the bouncing switch is activated by a key for a second time, the main system may sequentially turn off the power module inside each sub-system. Finally, the power to the main system is shut down to lower the static power consumption of the whole system.

To achieve these and other advantages and in accordance with the purpose of the invention, as embodied and broadly described herein, the invention provides a power supply. The power supply includes a main switch, a controller, a trigger circuit, a switching device and a maintenance circuit. The main switch is coupled to a power source and the controller is coupled to the main switch for receiving power provided by the main switch. The trigger circuit is coupled to the power source and the switching device is coupled to the trigger circuit and the maintenance circuit for maintaining the state of the main switch. When the switching device is activated by a first triggering, the trigger circuit turns off the main switch so that power is provided to the maintenance circuit and the controller and the maintenance circuit keeps the main switch in the conducting state. After receiving the power and being activated, the controller acquires the authority over the maintenance circuit so that maintenance circuit keeps the main switch in the conducting state.

The present invention also provides an alternative power supply. The power supply includes a main switch and a sequential control circuit. The main switch is coupled to a power source and the sequential control circuit has a switching device and a maintenance circuit. The switching device of the sequential control circuit is coupled to the power source and the maintenance circuit is coupled to the main switch and the switching device. The sequential control circuit sequentially emits a first group of predetermined control signals on activation. When the switching device is activated by a first triggering, the switching device conducts the main switch so that power is provided to the sequential control circuit. After the receiving the power and being activated, the maintenance circuit keeps the main switch in the conducting state.

The present invention also provides a switch apparatus. The switch apparatus includes a main switch, a trigger circuit, a switching device and an auxiliary switch. The main switch is coupled to a power source and the trigger circuit is coupled to the power source. The switching device is coupled to the trigger circuit and the auxiliary switch is coupled to the main switch for maintaining the state of the main switch.

Furthermore, to prevent erroneous operations in a conventional driving circuit due to noise and abnormalities resulting from a switch working in a conducting state for a long time to cause damages to the device, the present invention also provides a driving auxiliary circuit. An input end of the driving auxiliary circuit is coupled to a driving circuit and an output end of the driving auxiliary circuit is coupled to a switch. The driving auxiliary circuit includes a conversion circuit and a level-adjusting circuit. The conversion circuit couples between the driving circuit and the switch for converting a driving signal generated by the driving circuit. The level-adjusting circuit receives the driving signal converted through the conversion circuit and adjusts the level of the driving signal. Hence, when the input duty cycle of pulse width modulation (PWM) is in a normal vibrating state, the output is also in a vibrating state. Moreover, the level can be downward shifted to prevent erroneous operations caused by noise. On the other hand, when the input duty cycle of the PWM signal is 100%, the driving signal is converted into a low level signal to prevent the operating switch from entering into a prolonged conducting state.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic circuit diagram of a conventional power supply circuit.

FIG. 2A is a system block diagram of a power supply according to one preferred embodiment of the present invention.

FIG. 2B is a schematic circuit diagram of a power supply according to one preferred embodiment of the present invention.

FIG. 3 is a timing diagram showing the activating sequence of the power supply according to the present invention.

FIG. 4 is a timing diagram showing the shutting off sequence of the power supply according to the present invention.

FIG. 5 is a schematic circuit diagram of a 12V/5V conversion circuit of the power module according to an embodiment of the present invention.

FIG. 6 is a schematic circuit diagram of a 5V/VGH and 5V/VGL conversion circuits of the power module according to an embodiment of the present invention.

FIG. 7 is a schematic circuit diagram of an LED driving circuit of the power module according to an embodiment of the present invention.

FIG. 8 is a schematic circuit diagram of a driving auxiliary circuit according to one preferred embodiment of the present invention.

FIG. 9 is a timing diagram showing input signal and output signal of the driving auxiliary circuit according to one preferred embodiment of the present invention.

FIG. 10 is a timing diagram showing direct current (DC) input signal and output signal of the driving auxiliary circuit according to one preferred embodiment of the present invention.

FIG. 11 is a timing diagram showing the activating sequence of the power modules of the sub-system.

FIG. 12 is a timing diagram showing the shutting off sequence of the power modules of the sub-system.

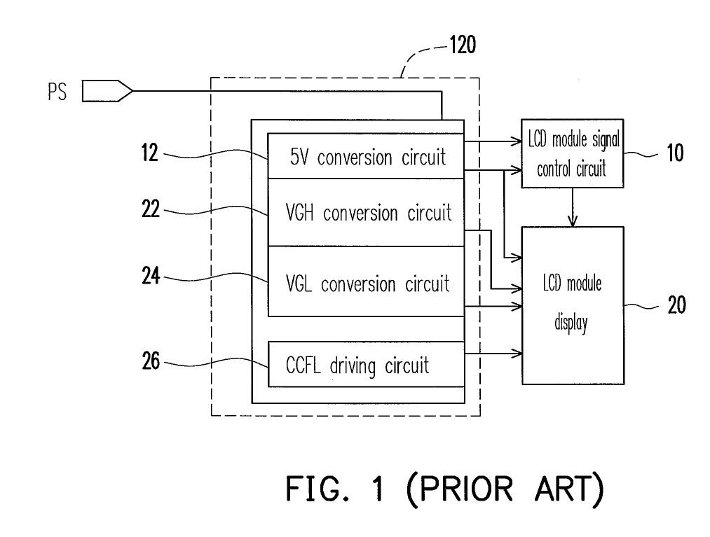

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

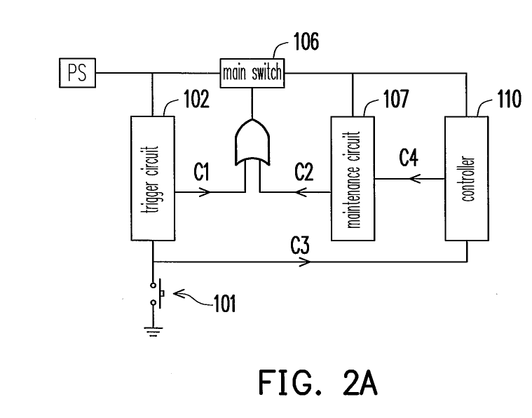

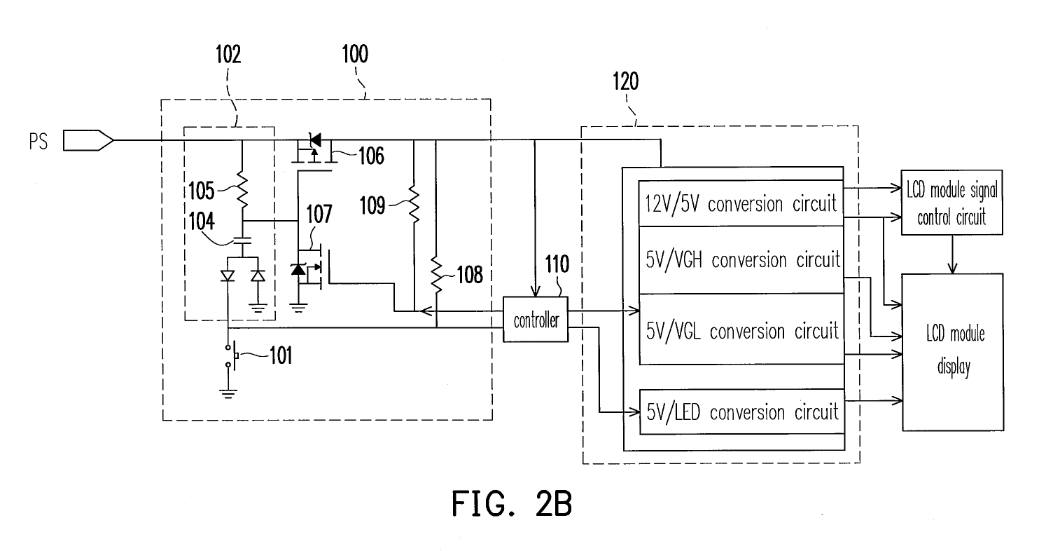

FIG. 2A is a system block diagram of a power supply according to one preferred embodiment of the present invention. As shown in FIG. 2A, when a switching device 101 is triggered for the first time, an activating signal C1 is transmitted to a main switch 106 so that the main switch 106 provides power from a power source PS to a maintenance circuit 107 and a controller 110. After receiving the power and being activated, the controller 110 transmits a maintenance signal C4 to the maintenance circuit 107 so that the maintenance circuit 107 continuously transmits a maintenance signal C2 to the main switch 106. The timing for activating the maintenance circuit 107 can be the time when the main switch 106 starts providing power source PS power or the time when the maintenance circuit 107 receives the maintenance signal C4. The actual operation of the present invention is unaffected by whether the maintenance circuit 107 is activated at the two aforementioned timings or anywhere between them. The trigger circuit 102 stops outputting the activating signal C1 after a predetermined period. At this moment, the maintenance circuit 107 has already transmitted the maintenance signal C2. Since the output of either the activating signal C1 or the maintenance signal C2 can trigger the main switch 106 to provide power source PS power, the controller 110 acquires the authorization of controlling the power of the system through the maintenance circuit 107. The controller 110 continuously monitors the state of the switching device 101. When the detection signal C3 indicates that the switch is triggered for a second time, the output of the maintenance signal C4 is stopped. Now that neither the activating signal C1 nor the maintenance signal C2 is output, the main switch 106 stops providing power source PS power. Therefore, the system power source in the present invention stops providing any power to maintain the system in an idle state after the system is shut down, thereby eliminating unnecessary power consumption in the idle state.

FIG. 2B is a schematic circuit diagram of a power supply according to one preferred embodiment of the present invention. As shown in FIG. 2B, the power supply includes a switch apparatus 100, a controller 110 and a sub-system 120. The switch apparatus 100 has a switching device 101, a trigger circuit 102, a main switch 106, a maintenance circuit 107 and a resistor 108. The trigger circuit 102 can be a RC circuit comprising a capacitor 104 and a resistor 105. The switching device 101 is coupled to a main power source PS through the trigger circuit 102. When the switching device 101 is triggered by a triggering for the first time, it does not matter whether the triggering time is long or short (in other words, the switching device 101 can be a bouncing switch, a mechanical switch, an infrared switch, a transistor switch or an open-to-short operating switch, the switch in FIG. 2B is a bouncing switch), this activation process prompts the trigger circuit 102 to transmit an activating signal to turn on the main switch 106 so that the controller 110 starts to operate. When the controller 110 operates, a maintenance signal is transmitted to the maintenance circuit 107 so that the maintenance circuit 107 keeps the main switch 106 in a conducting state. The maintenance circuit 107 can be an auxiliary switch, for example, a MOS transistor. Through the conduction of the auxiliary switch, the main switch 106 is maintained in a conducting state. Meanwhile, the controller 110 acquires the authorization of controlling the power of the main system so that the power source can continue to provide power to the main system. Then, according to a predetermined sequence, the controller 110 sequentially transmits enable signals to control the activation and operation of various power modules in the sub-system 120. The power module can be the 12V/5V conversion circuit, the 5V/VGH conversion circuit, the 5V/VGL conversion circuit, the 5V/LED conversion circuit as shown in FIG. 2B but is not limited as such.

The controller 110 continues to monitor the state of the switching device 101 after activation. When the switching device 101 is triggered by a triggering for a second time, for example, for a bouncing switch, the voltage suddenly drops from a high level to a low level, or, for a mechanical switch, the voltage suddenly jumps from a low level to a high voltage. When the controller 110 detects a voltage change in the switching device 101, the controller 110 sequentially outputs disable signals to shut down and stop the operation of various power modules in the sub-system. Furthermore, the controller 110 also transmits an auxiliary shut down control signal to turn off the auxiliary switch 107. After turning off the auxiliary switch 107, (directly through the auxiliary switch 107 or) through the trigger circuit 102, a shut down signal is transmitted to shut down the main switch 106 and stop outputting power to the main system. Thus, after shutting down the power source, there is no need for the power source to provide any power to maintain the main system and the sub-system in an idle state so that the advantage of a low static power consumption of the whole system is achieved. Moreover, in the activation and shut down process, the power modules are sequentially activated and shut down through the controller. Hence, various operations between system circuits within the system can be synchronized to prevent mutual interference or generation of undesired effects.

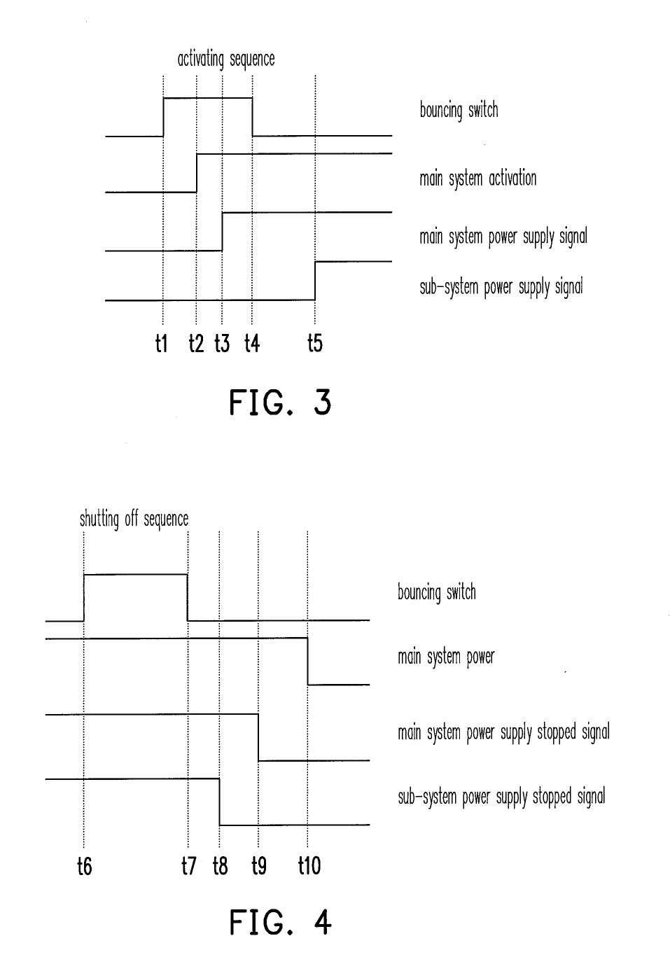

FIG. 3 is a timing diagram showing the activating sequence of the power supply according to the present invention. As shown in FIGS. 2A and 3, a bouncing switch is used as an example. The bouncing switch 101 is triggered for the first time in time t1 to generate an activating signal. Then, the main system (the controller 110) is activated at time t2. At time t3, a main system power supply signal is generated through the maintenance circuit 107 to acquire the authorization of controlling the power source of the main system. At time t4, the main system sequentially transmits a sub-system power supply signal to the power modules in the sub-system 120 so that various power modules are activated. The activating signal of the bouncing switch 101 stops at time t4. The time t4 must be later than time t3 to ensure that the controller 110 has already acquired the authorization of controlling the power of the main system.

FIG. 4 is a timing diagram showing the shutting off sequence of the power supply according to the present invention. As shown in FIGS. 2A and 4, when the bouncing switch 101 is triggered for the second time at time t6, a shut down signal is generated, and stopped at time t7. After the main system (the controller 110) has detected the shut down signal, the main system sequentially transmits a sub-system power supply stopping signal to various power modules in the sub-system 120 at time t8 so that various power modules are turned off in sequence. Then, the controller 110 generates a main system power supply stopping signal through the maintenance circuit 107 at time t9 to release the authorization of controlling the power of the main system. Afterwards, the supply of the main system power is stopped at time t10 due to the shut down of the main switch 106.

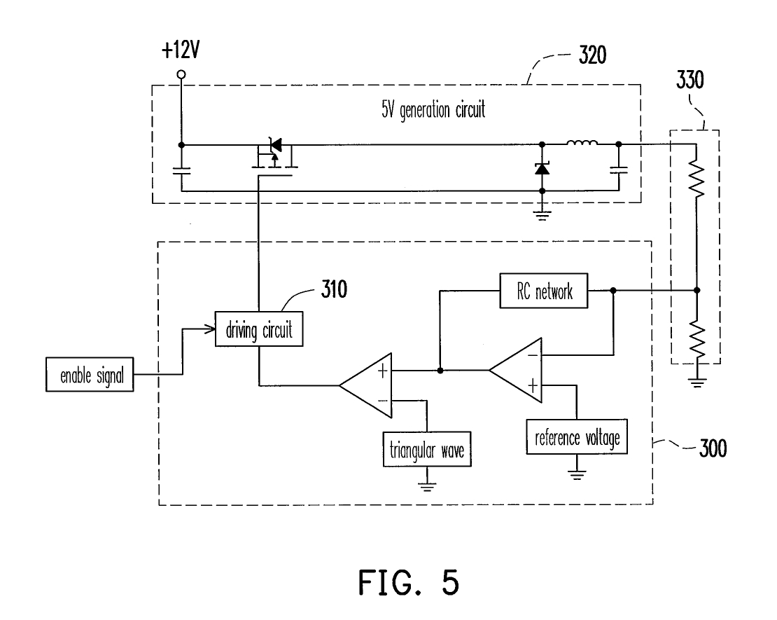

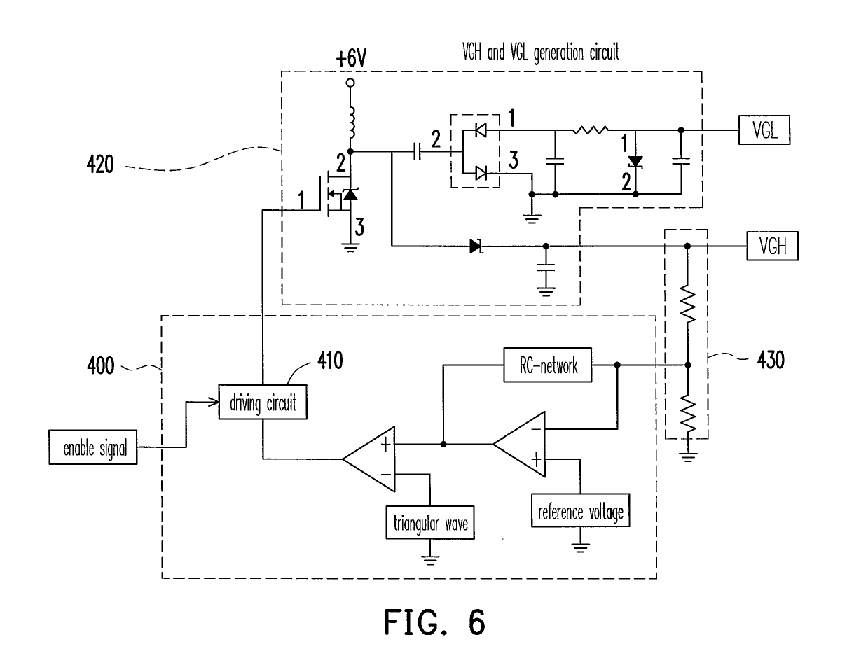

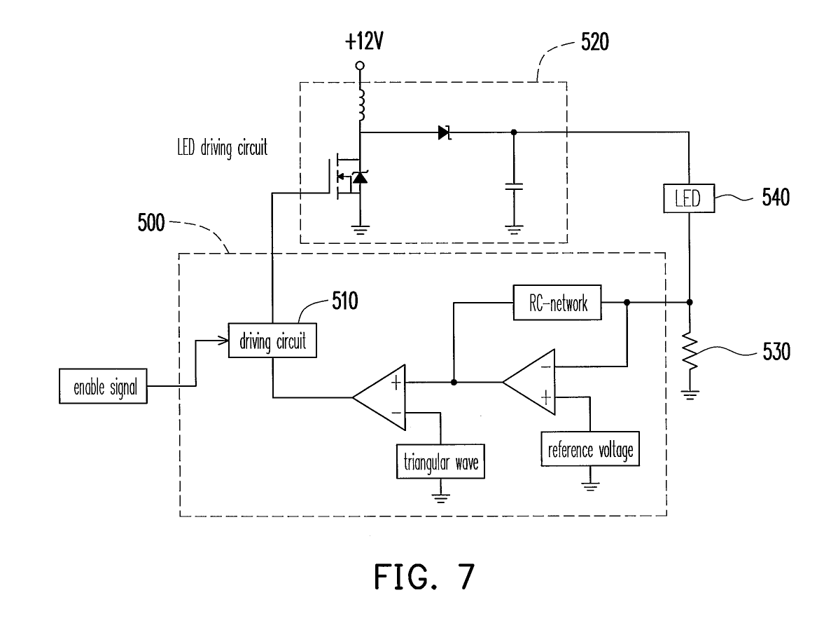

In the following, the circuits of various power modules in the sub-system 120 of FIG. 2B are described. FIG. 5 is a schematic circuit diagram of a 12V/5V conversion circuit of the power module in the present invention. As shown in FIGS. 2B and 5, after activating the controller 110, the controller 110 transmits an enable signal to the 12V/5V conversion circuit to activate the conversion controller 300. According to the control signal of the conversion controller 300, the driving circuit 310 transmits a driving signal to control the switching of the power switching circuit in the conversion circuit 320 so that the conversion circuit 320 converts the power from the power source to supply the system. The conversion controller 300 stabilizes the output voltage through the feedback signal of the feedback circuit 330. When the controller 110 detects the shut down signal (that is, a voltage change in the switch 101), disable signal is sequentially transmitted. When the conversion controller 300 receives the disable signal, the conversion controller 300 makes the driving circuit 310 stop outputting power from the power source to the conversion circuit 320. Furthermore, FIG. 6 is a schematic circuit diagram of a 5V/VGH and 5V/VGL conversion circuits of the power module according to an embodiment of the present invention. FIG. 7 is a schematic circuit diagram of an LED driving circuit of the power module according to an embodiment of the present invention. The operating principles of the controllers 400 and 500, the driving circuits 410 and 510 and the feedback circuits 430 and 530 in the 5V/VGH and 5V/VGL conversion circuits and the LED driving circuit are identical to that of the aforementioned 12V/5V conversion circuit. Hence, a detailed explanation is omitted. The VGH/VGL (positive gate voltage/negative gate voltage) conversion circuit in FIG. 6 comprises a step-up voltage circuit for generating the VGH voltage and a negative voltage circuit for generating the VGL voltage. The conversion circuit 520 in FIG. 7 is a step-up voltage circuit for generating a driving voltage to drive the LED light-emitting module 540. Since the operation of these conversion circuits should be familiar, a detailed description is omitted.

In addition, in a conventional power module, noise in the driving signal may lead to faulty switching of the power switching circuit. Alternatively, some special, abnormal states (for example, duty cycle at 100% so that the switch is kept in the conducting state at all times) may lead to short circuit, thereby damaging the device. In the present invention, a driving auxiliary circuit between the power switch and the driving circuit may be added. When the input terminal receives no driving signal, the voltage at the output terminal is defined as a low voltage so that the switch in the power switching circuit is kept in a shut down state. When the input terminal receives a driving signal, the output terminal outputs a converted driving signal so that the switch in the power switching circuit is turned off or turned on according to the driving signal.

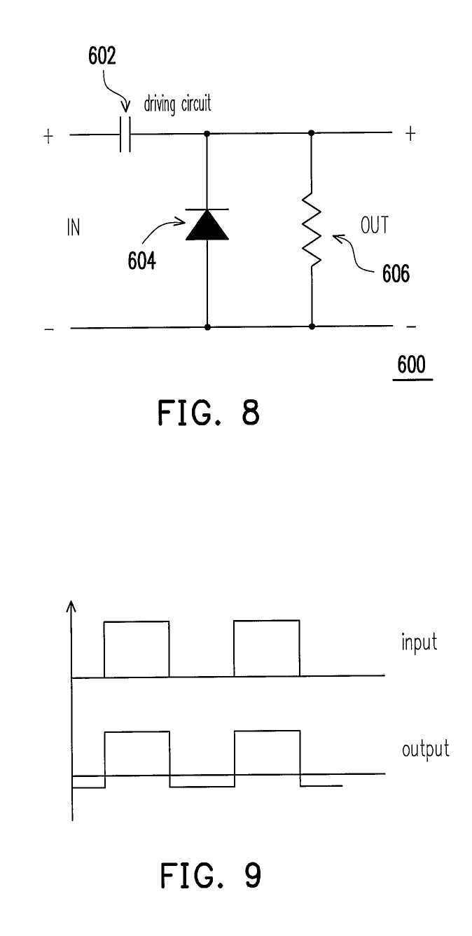

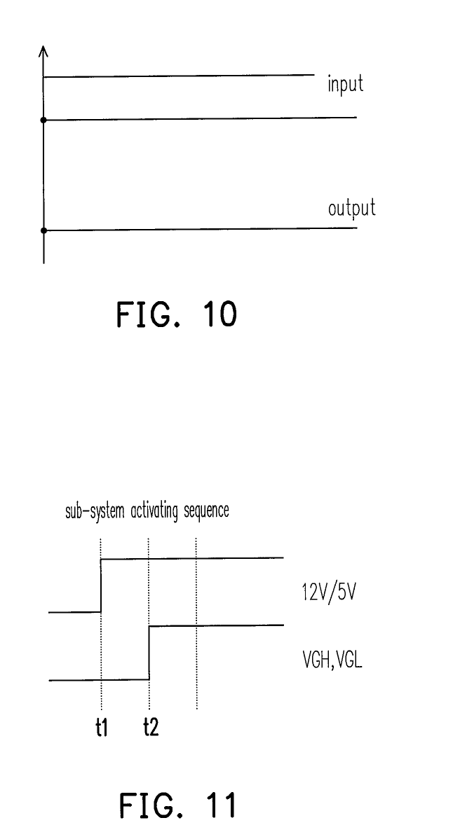

FIG. 8 is a schematic circuit diagram of a driving auxiliary circuit according to one preferred embodiment of the present invention. As shown in FIG. 8, the auxiliary driving circuit 600 includes a capacitor 602, a diode 604 and a resistor 606. The capacitor 602 is coupled between the driving circuit and the switch for filtering and converting the driving signal. The diode 604 and the resistor 606 are connected in parallel between the positive and the negative output terminals so that the level of the driving signal after conversion through the capacitor 602 is defined. Thus, when the input terminal IN of the driving auxiliary circuit 600 receives no signal, the resistor 606 forces the voltage at the output terminal OUT to a zero voltage. When the input terminal IN receives a driving signal, the driving signal converted through the capacitor 602 is output through the output terminal OUT. As shown in FIG. 9, if the input signal is a pulse signal produced by an oscillator in a common vibration mode, the output signal is pulled down after conversion through the capacitor 602. When the duty cycle of an input pulse width modulation (PWM) signal reaches 100%, the switch in the conventional technique is set to a short circuit conducting state for a prolonged period so that the device is very likely damaged. In the present invention, as shown in FIG. 10, after filtering out the DC component through the capacitor 602, a low level function representing a logic signal ‘0’ is output to prevent the operating switch from staying in the conducting state for a prolonged period.

In actual applications, the power modules in the sub-system of the present embodiment can be any power modules, for example, a voltage step-up power module, a voltage step-down power module, a DC/DC converter, a DC/AC converter, an AC/DC converter, an AC/AC converter. However, the power modules are not limited as such.

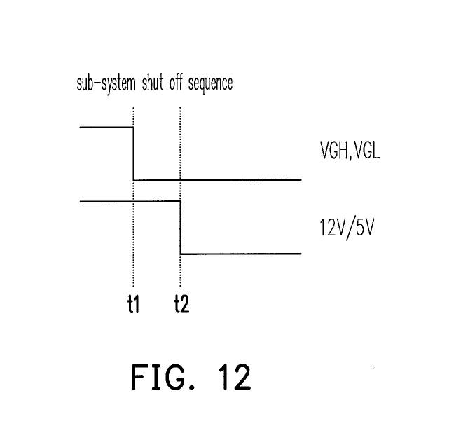

In actual applications, the activation sequence of the power modules in the sub-system is limited by the device to be driven. For example, the power module for driving the LCD module display must be provided with a voltage of 5V before providing the VGH/VGL voltage. FIG. 11 is a timing diagram showing the activating sequence of the power modules of the sub-system. As shown in FIG. 11, the activation sequence of the power modules in the sub-system is the 12V/5V conversion circuit and then the VGH/VGL conversion circuit. The controller 110 in FIG. 2B also transmits an enable signal to the 12V/5V conversion circuit and the VGH/VGL conversion circuit in that order. In the process of shutting down the power modules in the sub-system, the VGH/VGL conversion circuit must be shut down before the 12V/5V conversion circuit. FIG. 12 is a timing diagram showing the shutting down sequence of the power modules in the sub-system. As shown in FIG. 12, the controller 110 transmits a disable signal in sequence to the VGH/VGL conversion circuit and the 12V/5V conversion circuit. For some of the conversion circuit having no special activation or sequentially shutting requirements like the LED driving circuit in FIG. 7 can be independently controlled. In other words, the timing for activating or shutting these conversion circuits can be freely set. However, the timing for activating or shutting off various conversion circuits are preferably set as far apart as possible to prevent high voltage ripple problem caused by the simultaneous activation or shutting of circuits.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A power supply, comprising:
a main switch, coupled to a power source;
a controller, coupled to the main switch for receiving a power provided through the main switch;
a trigger circuit, coupled to the power source;
a switching device, coupled to the trigger circuit; and
a maintenance circuit, for keeping the state of the main switch;
wherein, when the switching device is triggered by a first triggering, the trigger circuit makes the main switch conduct to provide power to the controller, and after receiving the power and being activated, the controller controls the maintenance circuit to keep the main switch in the conducting state.

2. The power supply of claim 1, wherein the switching device is a bouncing switch, a mechanical switch, an infrared switch or a transistor switch.

3. The power supply of claim 1, further comprising a plurality of power modules, wherein after the controller is activated, the controller sequentially transmits a first group of predetermined control signals, and after receiving the first group of predetermined signals, the power modules are activated.

4. The power supply of claim 3, wherein the plurality of power modules are connected to the power source.

5. The power supply of claim 3, wherein the trigger circuit is a resistor-capacitor (RC) circuit.

6. The power supply of claim 1, wherein the maintenance circuit includes a metal oxide semiconductor (MOS) transistor.

7. The power supply of claim 1, wherein the controller is also coupled to the switching device for detecting the conducting state of the switching device.

8. The power supply of claim 7, wherein after detecting a second triggering of the switching device, the controller sequentially transmits a second group of predetermined control signals.

9. The power supply of claim 8, further comprising a plurality of power modules, wherein after receiving the second group of predetermined control signals, the power modules are shut down.

10. The power supply of claim 7, wherein, when the controller detects a second triggering of the switching device, the controller controls the maintenance circuit to transmit a shut down signal to the main switch so that the main switch stops providing power.

11. The power supply of claim 1, further comprising a clamping circuit coupled between the switching device and the trigger circuit.

12. A power supply, comprising:
a main switch, coupled to a power source; and
a sequential control circuit, having a switching device and a maintenance circuit, wherein the switching device is coupled to the power source and the maintenance circuit is coupled to the main switch and the switching device, and the sequential control circuit, on activation, sequentially transmits a first group of predetermined control signals;
wherein, when the switching device is triggered by a first triggering, the switching device make the main switch conduct to provide power to the sequential control circuit, and after receiving the power and being activated, the maintenance circuit keeps the main switch in the conducting state.

13. The power supply of claim 12, wherein the switching device is a bouncing switch, a mechanical switch, an infrared switch or a transistor switch.

14. The power supply of claim 12, further comprising a plurality of power modules, wherein after receiving the first group of predetermined control signals, the power modules are activated.

15. The power supply of claim 14, wherein the plurality of power modules are connected to the power source.

16. The power supply of claim 12, wherein the maintenance circuit is a MOS transistor.

17. The power supply of claim 12, wherein after detecting a second triggering of the switching device, the sequential control circuit sequentially transmits a second group of predetermined control signals.

18. The power supply of claim 12, further comprising a plurality of power modules, wherein after receiving the second group of predetermined control signals, the power modules are shut down.

19. The power supply of claim 12, wherein after detecting a second triggering of the switching device, the sequential control circuit controls the maintenance circuit to transmit a shut down signal to the main switch so that the main switch stops providing power.

20. A driving auxiliary circuit, having an input terminal coupled to a driving circuit and having an output terminal coupled to a switch, comprising:
a conversion circuit, coupled between the driving circuit and the switch for converting a driving signal generated by the driving circuit; and
a level-adjusting circuit for receiving the driving signal converted by the conversion circuit and adjusting the level of the driving signal.

21. The driving auxiliary circuit of claim 20, wherein the conversion circuit is a capacitor.

22. The driving auxiliary circuit of claim 21, wherein the level-adjusting circuit comprises a resistor and a diode, and the resistor is parallel to the diode.

23. The driving auxiliary circuit of claim 20, wherein the conversion of the capacitor functions as a filter for filtering out the DC component of the driving signal.
